(19) United States
(12) Patent Application Publication
(10) Pub. No.: US 2026/0172273 A1
(43) Pub. Date: Jun. 18, 2026

(54) VIDEO CONFERENCE PARTICIPANT SESSION IMPROVEMENT

(71) Applicant: INTERNATIONAL BUSINESS MACHINES CORPORATION, ARMONK, NY (US)

(72) Inventors: Kelley Anders, East New Market, MD (US); Jonathan David Dunne, Dungarvan (IE); Andrew Thomas Penrose, Castleknock (IE)

(21) Appl. No.: 19/039,947

(22) Filed: Jan. 29, 2025

(30) Foreign Application Priority Data
Dec. 12, 2024 (GB) 2418224.8

(51) Int. Cl. H04L 12/18

(52) U.S. Cl. CPC H04L 12/1818

(57) ABSTRACT

A method, computer program product, and computer system for video conference participant session improvement are provided. The method captures parameters of independent features of a participant video conference session, wherein the independent features include physical configurations of a video conference setup of a participant. The method obtains a feedback rating for the participant video conference session and applies model analysis of the participant video conference session based on the feedback rating and the parameters of the independent features to obtain a session effectiveness score. The method provides calibration suggestions of the parameters of the independent features to improve video conference sessions of the participant.

### BACKGROUND

The present invention relates to video conference sessions, and more specifically, to improving video conference participant sessions.

Video conferencing is a key tool in business for interacting with other people. It is often the case that communication and impact by a participant are lost through poor quality use of video conferencing configurations and delivery. Specific techniques can be applied to increase a participant's effectiveness by improving interaction clarity and impact.

Factors related to meeting effectiveness include: a presenter's position relative to their camera and microphone, the audio and visual quality of the system used, and the lighting provided. Participants often do not to take time to set up their own environment optimally. It is also difficult for participants to be aware of how their sessions are received by other participants.

### SUMMARY

According to an aspect of the present invention there is provided a computer-implemented method for video conference participant session improvement, said method comprising: capturing parameters of independent features of a participant video conference session, wherein the independent features include physical configurations of a video conference setup of the participant; obtaining a feedback rating for the participant video conference session; applying model analysis of the participant video conference session based on the feedback rating and the parameters of the independent features to obtain a session effectiveness score; and providing calibration suggestions of the parameters of the independent features to improve the video conference sessions of the participant. According to another aspect of the invention there is provided a system for video conference participant session improvement, comprising: a processor and a memory configured to provide computer program instructions to the processor to execute a method of: capturing parameters of independent features of a participant video conference session, wherein the independent features include physical configurations of a video conference setup of the participant; obtaining a feedback rating for the participant video conference session; applying model analysis of the participant video conference session based on the feedback rating and the parameters of the independent features to obtain a session effectiveness score; and providing calibration suggestions of the parameters of the independent features to improve the video conference sessions of the participant.

According to a further aspect of the invention there is provided a computer program product for video conference participant session improvement, the computer program product comprising a computer readable storage medium having program instructions embodied therewith, the program instructions executable by a processor to cause the processor to: capture parameters of independent features of a participant video conference session, wherein the independent features include physical configurations of a video conference setup of the participant; obtain a feedback rating for the participant video conference session; apply model analysis of the participant video conference session based on the feedback rating and the parameters of the independent features to obtain a session effectiveness score; and provide calibration suggestions of the parameters of the independent features to improve the video conference sessions of the participant.

The method has the advantage of providing calibration suggestions to improve meeting effectiveness based on feedback in combination with parameters of physical configurations of the video conference setup using a model analysis. The model analysis may use logistic regression model analysis including weightings of the parameters indicating contributions of the parameters to the effectiveness of the participant meeting session.

The computer readable storage medium may be a non-transitory computer readable storage medium and the computer readable program code may be executable by a processing circuit.

The present invention seeks to provide one or more concepts of video conference participant session improvement. Such concepts may be computer-implemented. That is, such methods may be implemented in a computer infrastructure having computer executable code tangibly embodied on a computer readable storage medium having programming instructions configured to perform a proposed method. The present invention further seeks to provide a computer program product including computer program code for implementing the proposed concepts when executed on a processor.

### BRIEF DESCRIPTION OF THE DRAWINGS

Embodiments of the present invention will now be described, by way of example only, with reference to the accompanying drawings:

FIG. 1 is a flow diagram of an example embodiment of a method in accordance with embodiments of the present invention;

FIG. 2 is a block schematic diagram illustrating an example embodiment of the described method;

FIG. 3 is a schematic diagram of an example embodiment of a video conference participant session implementing the described method;

FIG. 4 is a block diagram of an example embodiment of a system in accordance with embodiments of the present invention; and

FIG. 5 is a block diagram of an example embodiment of a computing environment for the execution of at least some of the computer code involved in performing the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for improvement of video conference participant sessions. A session may be a meeting, a series of meetings, or a portion of a meeting. A video conference session may be carried out via a web based or downloaded video conferencing system. The effectiveness of video conference sessions for a participant is reliant on physical configurations of the session. The physical configurations may include the audio quality and the visual quality of the computing system as well as components of a physical environment captured in the session.

The effectiveness of a video conference session for a participant is most accurately evaluated by other participants of the session and the described method obtains a feedback rating for a participant video conference session which is used for improvement analysis. Physical system and environmental data are captured using multi-modal techniques in the described method combines the captured data with the feedback for improvement modeling.

The described method applies model analysis of a participant video conference session based on feedback ratings and parameters of the physical configurations, as well as optionally other input features, to obtain a session effectiveness score. Calibration suggestions are provided based on the session effectiveness score to improve the video conference sessions of the participant.

The method automatically provides a score for a video conference session and may identify mitigating factors that impede the meeting's effectiveness. This may be provided by building a meeting effectiveness quotient (MEQ) based on the physical data and participant feedback to determine a meeting's effectiveness.

The video conference participant session improvement is provided in the technical field of video conferencing and online meetings.

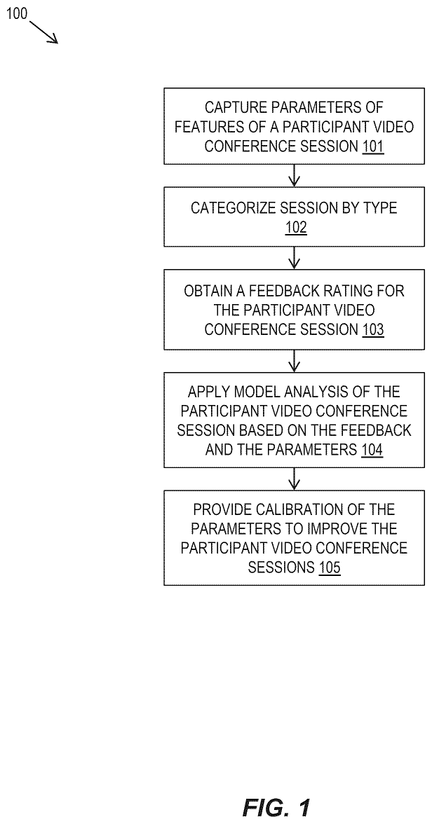

Referring to FIG. 1, a flow diagram 100 shows an example embodiment of the described method for video conference participant session improvement.

The method includes capturing 101 parameters of independent features of a participant video conference session. The independent features include physical configurations of a video conference system settings of the participant. The physical configurations may include system configurations such audio settings and visual settings. The physical configurations may include an environment setup of the participant such as their position, lighting, room arrangement, and objects captured in the video conference field of view. Independent features of a participant video conference session may also include independent features of participant input characteristics, such as the participant's physiological signals. Physiological signals may include the intensity or nature of facial expressions, speech characteristics, gestures, etc.

Capturing 101 parameters of independent features of a participant video conference session may use a multi-modal analysis of the physical configuration features. Multi-modal analysis analyzes the audio and visual streams as distinct entities (modes).

Capturing 101 parameters of physical configurations may be carried out by an extension to the video conferencing system being used by the participant. In the case of independent features in the form of physical configurations of the environment, the capturing may include object detection in a video display area.

Capturing 101 parameters of the environmental setup may include object detection in the field of view of the video display area. This may detect background objects and foreground objects such as the presenter, and may capture and analyze the object positions, lighting, and consequently the objects' impact in the display.

The method may categorize 102 a participant video conference session by a session type. A session type may include a time of day of a session, a room type, a number of participants, such as a one-to-one session vs a large group session, etc. The categorization of session type may extend to a domain or profile of the participants. A domain or profile may relate to role categories, or other participant categories. As an example, a remote worker in a non-office environment may have a different profile to an office-based worker.

The method may obtain 103 a feedback rating for the participant video conference session. The feedback rating may be obtained by one or more other participants of the video conferencing session. The feedback may be obtained by a feedback form presented to participants at the end of a session.

The method applies 104 model analysis of the participant video conference session based on the feedback rating and the parameters of the independent features to obtain a session effectiveness score. Applying 104 model analysis may be based on a session type when sessions are categorized by type. Applying 104 model analysis may be across multiple domains or profiles. The session effectiveness score may be provided for a session type, domain or profile.

Applying 104 model analysis may apply a logistic regression model analysis with the feedback rating as a dependent variable and the parameters as independent variables. The model analysis may be carried out by a machine learning method and the machine learning model may be trained across session types including participant domains or profiles.

The session effectiveness score may include weights of the independent features indicating their influence on the feedback rating and providing calibration suggestions of the parameters of the independent features based on the weights of the independent features. The session effectiveness score may use a normalized scale. The session effectiveness score may be referred to herein as a meeting effectiveness quotient (MEQ).

The method provides 105 calibration suggestions of the parameters of the independent features to improve the video conference sessions of the participant. Providing 105 calibration suggestions may provide a display or prompt of the calibration suggestions in the participant's video conference system.

One or more calibration suggestions may be used to automatically configure one or more video conference sessions. E.g. audio settings, video settings and lighting settings may be automatically configured based on the analysis performed. Some settings may still need to be configured manually.

Where capturing parameters of physical configurations is carried out by an extension to a video conferencing system, providing calibration suggestions may provide a configuration of the parameters via the extension.

Where capturing parameters of independent features applies object detection in a video display area, providing calibration suggestions may provide object positioning suggestions in a remediated view.

Where capturing parameters of independent features of a participant video conference session also includes independent features of participant input characteristics, providing calibration suggestions of the parameters of the independent features provides participant input suggestions.

The session effectiveness may be calibrated for improvement over different session types, domains and profiles. The calibration may mitigate the factors that impede a session's effectiveness as well as promote the factors that promote a sessions effectiveness.

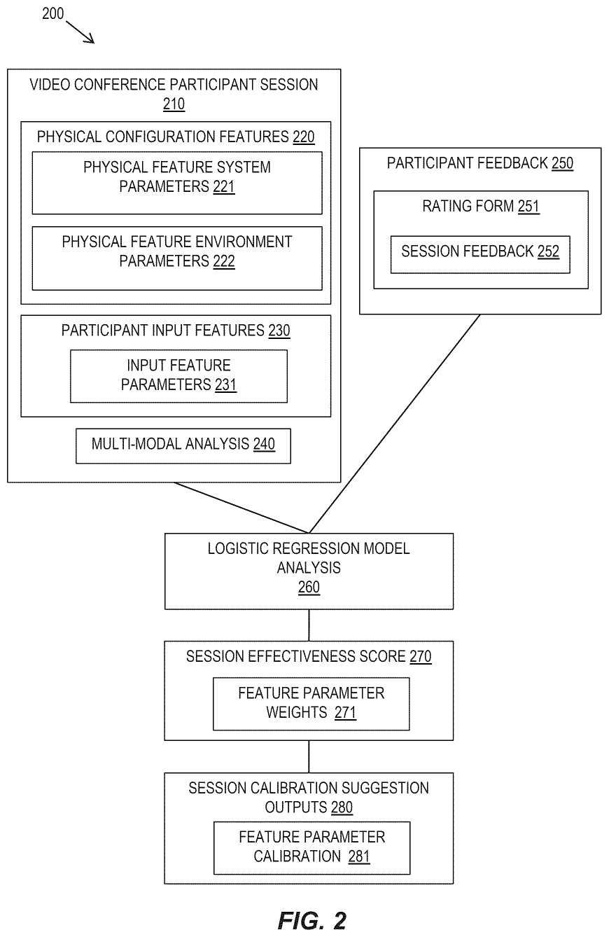

Referring to FIG. 2, a block diagram 200 shows a schematic illustration of the described method.

A video conference participant session 210 is shown which has physical configuration features 220. The physical configuration features 220 may be video conferencing system features and/or environmental features. The video conferencing system features may be audio or visual system controls. The environmental features may relate to the positioning of objects or lighting in the environment captured by the video conference, such as a room or background. The physical configuration features 220 have physical feature parameters that may be a measure of the features such as their intensity, position, or other measure. The physical feature parameters may include physical feature system parameters 221 of the video conferencing system for the session. The physical feature parameters may include physical feature environment parameters 222 of the environmental setup of the session.

The video conference participant session 210 may also have participant input features 230 in the form of physiological inputs by the participant. The participant input features 230 have input feature parameters 231 that may be a measure of the inputs such as an intensity, an emotion, an impact, etc.

A multi-modal analysis 240 may measure the physical feature parameters 221, 222 and the input feature parameters 231 using different methods of audio and visual measurements and analysis. The multi-modal analysis 240 may be conducted on the environment (such as a room) to measure features such as speaker placement, call quality, lighting, etc. The multi-modal analysis 240 may also be carried out on the participant input such as, expression, speech, gesture, physiological signals, that may all be measured as an intensity. The input features may be captured by biometric activity of the participant such as gaze direction, closed eyes, heart rate, speech cadence or velocity.

Participant feedback 250 is obtained, for example, using a rating form 251 for session feedback 252 for a participant. The participant feedback 250 may be provided by one or more other participants or observers of the session.

A logistic regression model analysis 260 may be carried out to produce a session effectiveness score 270 that may include feature parameter weightings 271. The weightings may be provided by the model for each feature indicating the importance of feature parameters to the score. The session effectiveness score 270 may be trained across multiple domains or profiles. The participant feedback as a dependent variable may be combined with the physical and input features as independent variables and analyzed using logistic regression.

Session calibration suggestion outputs 280 may be provided with feature parameter calibration 281 for improved sessions by the participant. Some of the parameter calibrations 281 may be applied physically at the video conferencing system or to the environment. Other parameter calibrations 281 may be suggestions regarding participant input characteristics.

The logistic regression may apply the equation of:

$$P = \frac{{e}^{a + b X}}{1 + {e}^{a + b X}}$$

$${P}_{meeting \_ effectiveness} = {e}^{feature 1 ( weight ) + feature 2 ( weight ) + feature 3 ( weight ) + intercept} / 1 + {e}^{feature 1 ( weight ) + feature 2 ( weight ) + feature 3 ( weight ) + intercept}$$

### Logistic Regression Weight Determination

Logistic regression weights (or coefficients) are determined using a method called maximum likelihood estimation (MLE). This method finds the values of the coefficients that make the observed data most probable under the logistic model.

A logistic regression model is defined in which the probability p that a given observation belongs to a particular class is based on a linear combination of predictor variables. A likelihood of observed data is calculated. For logistic regression, the likelihood function expresses the probability of observing the given data as a function of the model parameters for which weights are determined. For each observation, the probability p is calculated that the response variable takes on the observed value. For a binary outcome, the likelihood function for all N observations can determined and a log of the likelihood function taken.

Since the likelihood function is a product of probabilities, it can become extremely small, leading to numerical instability. Taking the natural logarithm of the likelihood, called the log-likelihood, simplifies this by turning the product into a sum. The log-likelihood is maximized to find the values of the coefficients (weights) that maximize the log-likelihood. This is typically done using an iterative optimization algorithm, such as gradient descent or Newton-Raphson methods. These algorithms adjust the coefficients step-by-step, moving towards values that maximize the log-likelihood.

Once the algorithm converges, the resulting coefficients are the weights that maximize the likelihood of observing the data under the logistic regression model. These weights can then be used to interpret the relationship between predictor variables and the probability of the outcome.

Each coefficient represents the change in the log odds of the outcome for a one-unit increase in the predictor variable. In practical terms: a positive coefficient suggests that as the predictor increases, the probability of the outcome increases; and a negative coefficient suggests that as the predictor increases, the probability of the outcome decreases.

An example of parameters of a logistic regression model and their coefficients as well as the importance of each feature is illustrated below for the features of lighting and height of the presenter in the field of view in a video conference session.

The generalized linear model (GLM) is:

$$glm ( formula = response \sim predictor ( lighting + height ) , family = binomial , data = data )$$

### Deviance Residuals:

| Minimum | 1 Quarter | Median | 3 Quarter | Maximum |
|---|---|---|---|---|
| −1.68642 | −0.93934 | 0.12701 | 0.79510 | 1.56833 |

### Coefficients

| | Est Std | Error z | Value | Pr(>\|z\|) |
|---|---|---|---|---|
| (Intercept) | −10.34425 | 4.72638 | −2.188 | 0.0288* |
| Lighting | 0.17326 | 0.08932 | 1.940 | 0.0523 |
| Height | 0.00013 | 0.00008 | 1.500 | 0.1336 |

Significance codes: 0 ‘***’ 0.001 ‘**’ 0.01 ‘*’ 0.05 ‘ ’ 0.1 ‘ ’ 1
(Dispersion parameter for binomial family taken to be 1)
Null deviance: 13.862 on 9 degrees of freedom
Residual deviance: 8.424 on 7 degrees of freedom
AIC: 14.424
Number of Fisher Scoring iterations: 4

The smaller the Pr(>|z|) value means the more important the feature. The output of the model provides the weights that can be used for calibration suggestions for future sessions. For example, as the p value of lighting is 0.0523 this is more important than height with a p value of 0.1336. The calibration of lighting is therefore deemed more sensitive to allow for a more optimal meeting experience.

From the multi-modal analysis, the model may measure independent features of the participant session. From the participant feedback, it may be determined whether a participant session was effective or not.

A participant session effectiveness quotient may provide a score of 0 to 1 of how effective a session was as well as providing a series of weights as to the influence of the features on the session.

The combination of logistic regression and multi-modal analysis may be used to calibrate a participant's physical system and environment and delivery to improve meeting effectiveness.

A video conference system plugin or extension may be used to monitor features. For example, the following features may be automatically measured:
Audio quality—a Perceptual Evaluation of Speech Quality (PESQ) score, latency,
Video quality—a Perceptual Evaluation of Video Quality (PEVQ) score,
Lighting quality—lux

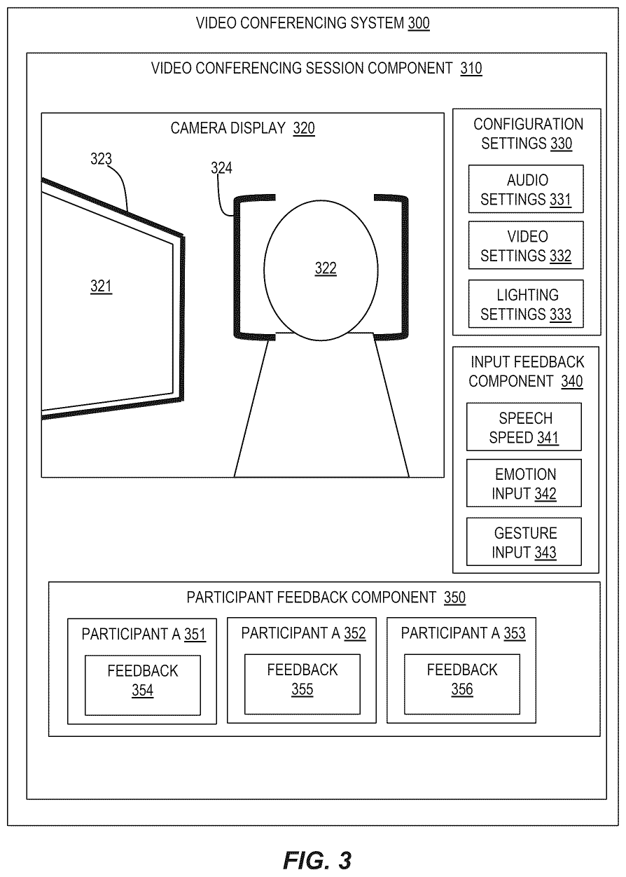

Referring to FIG. 3, a schematic diagram shows an example embodiment of a video conferencing system 300 with a video conferencing session component 310 that may provide calibration inputs before a session is started.

The calibration inputs may be provided to a participant based on feedback from the participant's previous sessions. A participant feedback component 350 may be provided for providing feedback on other participants at the end of a session. For example, this may include feedback forms 354, 355, 356 for different participants 351, 352, 353.

The calibration inputs may be provided using a camera display 320 that shows a preview of the output of the participant's system and environment. The display 320 may show the participant position 322 with a graphic 324 showing an improved position. The display 320 may also show objects 321 in the display that detract from the output and a graphic 323 may identify such objects. In this way, the calibration may be applied to the participant's environment using asymmetric position indicators. A remediated view may be provided.

The calibration inputs may be provided by automated configuration settings 330 for the video conferencing system 300, such as for audio settings 331, video settings 332, and lighting settings 333. The automated configuration settings 330 may be provided as an exported file to the participant's system. Distracting background objects may be automatically blurred using a blur feature of the video conferencing system. Physical settings may also be prompted such as improving room lighting by turning on artificial light sources.

The calibration inputs may be provided by an input feedback component 340 that may provide calibrations for participant inputs such as speech speed 341, emotion input 342, gesture input 343. These participant inputs are examples, and other prompts may be provided during a session, such as prompting a user to look at the camera if a lack of eye contact is detected.

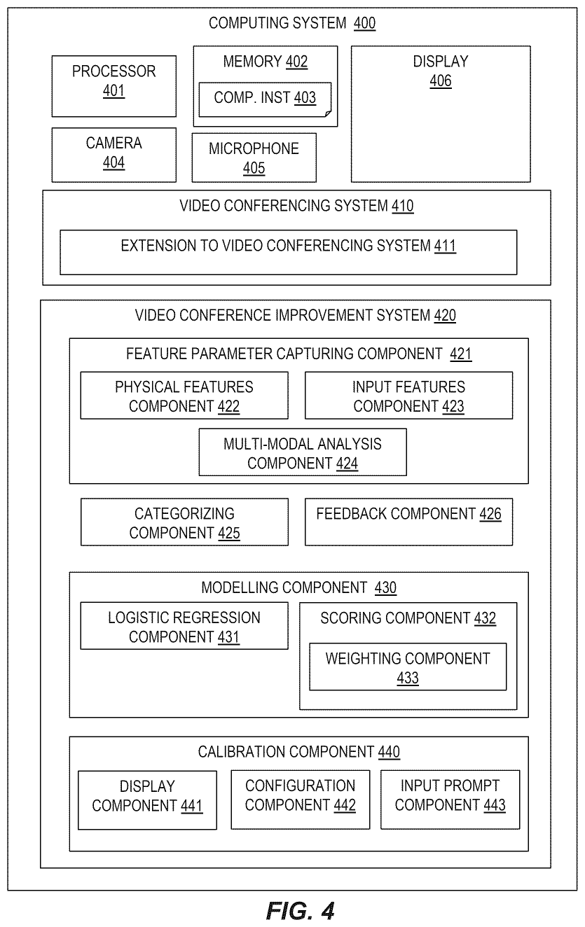

Referring to FIG. 4, a block diagram shows a computing system 400 in which the described system may be implemented. The computing system 400 may include at least one processor 401, a hardware module, or a circuit for executing the functions of the described components which may be software units executing on the at least one processor. Multiple processors running parallel processing threads may be provided enabling parallel processing of some or all of the functions of the components. Memory 402 may be configured to provide computer instructions 403 to the at least one processor 401 to carry out the functionality of the components.

The computing system 400 may include a camera 404 and microphone 405 for capturing the participant's image and voice. The computing system 400 may include a display 406 for the participant to see their output and inputs from other participants of a video conferencing session. The computing system 400 may execute a video conferencing system 410, for example, as a web-based application or as downloaded software on the computing system 400.

A video conference improvement system 420 may be provided as an extension to the video conferencing system 410. The video conference improvement system 420 may include the following components providing software instructions.

A feature parameter capturing component 421 may be provided for capturing parameters of independent features of a participant video conference session. The feature parameter capturing component 421 may include a physical features component 422 for capturing physical configurations of a video conference set up of the participant. The feature parameter capturing component 421 may include an input features component 423 for capturing independent features of participant input characteristics. The feature parameter capturing component 421 may include a multi-modal analysis component 424 for capturing parameters of independent features using a multi-modal analysis.

A categorizing component 425 may be provided for categorizing a participant video conference session by a session type, domain, or profile and applying model analysis based on the session type.

A feedback component 426 may be provided for obtaining a feedback rating for the participant video conference session.

A modeling component 430 may be provided for applying model analysis of the participant video conference session based on the feedback rating and the parameters of the independent features. The modeling component 430 may include a logistic regression component 431 for applying a logistic regression model analysis with the feedback rating as a dependent variable and the parameters as independent variables.

The modeling component 430 may include a scoring component 432 for providing a session effectiveness score. The scoring component 432 may include a weighting component 433 for providing weights of the independent features indicating their influence on the feedback rating.

A calibration component 440 may be provided for providing calibration suggestions of the parameters of the independent features to improve the video conference sessions of the participant.

The calibration component 440 may include a display component 441 for providing a display of the calibration suggestions in the participant's video conference system, such as object positioning suggestions in a remediated view.

The calibration component 440 may include a configuration component 442 for applying configurations of settings to the video conferencing system including based on the weights of the independent features.

The calibration component 440 may include an input prompt component 443 for providing calibration suggestions as participant input suggestions.

The feature parameter capturing component 421 may be provided as an extension 411 to the video conferencing system 410. The calibration component 440 may provide a configuration of the parameters via the extension 411.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

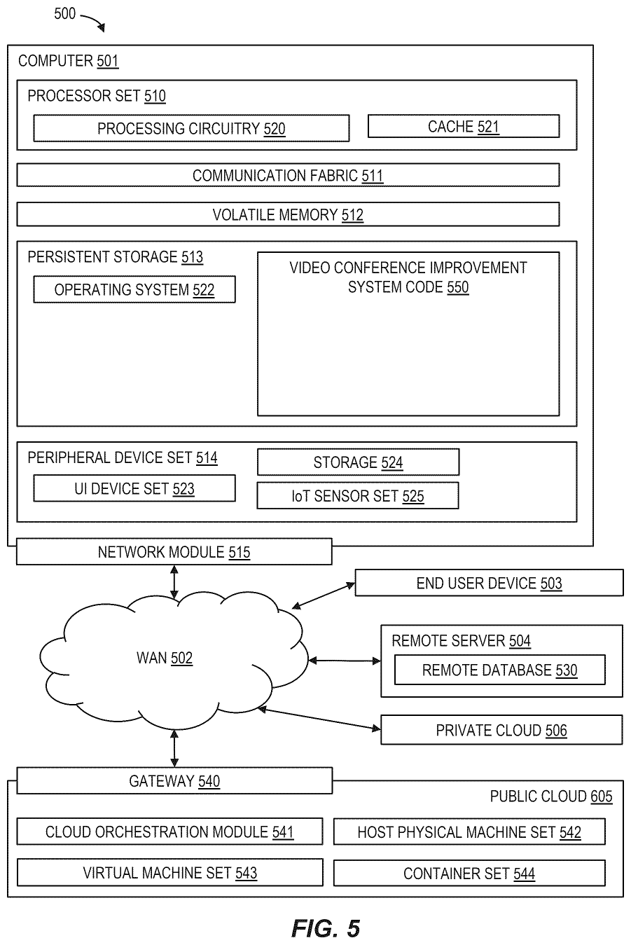

Referring to FIG. 5, computing environment 500 contains an example of an environment for the execution of at least some of the computer code involved in performing the inventive methods, such as video conference improvement system code 550. In addition to block 550, computing environment 500 includes, for example, computer 501, wide area network (WAN) 502, end user device (EUD) 503, remote server 504, public cloud 605, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI) device set 523, storage 524, and Internet of Things (IOT) sensor set 525), and network module 515. Remote server 504 includes remote database 530. Public cloud 605 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 541. The computing resources provided by public cloud 605 are typically implemented by virtual computing environments that run on various computers making up the computers of host physical machine set 542, which is the universe of physical computers in and/or available to public cloud 605. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 605 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 605, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 506 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

1. A computer-implemented method for video conference participant session improvement, the computer-implemented method comprising:
capturing parameters of independent features of a participant video conference session, wherein the independent features include physical configurations of a video conference setup of a participant;
obtaining a feedback rating for the participant video conference session;
applying model analysis of the participant video conference session based on the feedback rating and the parameters of the independent features to obtain a session effectiveness score; and
providing calibration suggestions of the parameters of the independent features to improve video conference sessions of the participant.

2. The computer-implemented method of claim 1, wherein capturing the parameters of the independent features of the participant video conference session further comprises using a multi-modal analysis of the independent features of an audio and visual stream of the participant video conference session.

3. The computer-implemented method of claim 1, wherein capturing the parameters of the independent features of the participant video conference session further comprises capturing the independent features in a form of video conferencing system settings, wherein providing the calibration suggestions of the parameters of the independent features includes providing a video conference system settings configuration.

4. The computer-implemented method of claim 1, wherein capturing the parameters of the independent features of the participant video conference session further comprises capturing the independent features in a form of environment setup features, wherein providing the calibration suggestions of the parameters of the independent features includes providing environment setup prompts.

5. The computer-implemented method of claim 1, wherein capturing the parameters of the independent features in a form of the physical configurations includes object detection in a video display area, and providing the calibration suggestions includes providing object positioning suggestions in a remediated view.

6. The computer-implemented method of claim 1, wherein capturing the parameters of the independent features of the participant video conference session includes the independent features of participant input characteristics, and wherein providing the calibration suggestions of the parameters of the independent features includes providing participant input prompts.

7. The computer-implemented method of claim 1, wherein applying the model analysis further comprises applying a logistic regression model with the feedback rating as a dependent variable and the parameters as independent variables with coefficients of the logistic regression model providing weighting indications for the parameters.

8. The computer-implemented method of claim 1, wherein the session effectiveness score includes weights of the independent features indicating an influence of the independent features on the feedback rating, and providing the calibration suggestions of the parameters of the independent features based on the weights of the independent features.

9. The computer-implemented method of claim 1, further comprising categorizing the participant video conference session by a session type and applying the model analysis based on the session type.

10. The computer-implemented method of claim 1, wherein providing the calibration suggestions comprise providing a display of the calibration suggestions in a participant's video conference system.

11. The computer-implemented method of claim 1, wherein capturing the parameters of the physical configurations is carried out by an extension to a video conferencing system, and wherein providing the calibration suggestions includes providing a configuration of the parameters via the extension.

12. A system for video conference participant session improvement, comprising:
a processor and a memory configured to provide computer program instructions to the processor to execute a method of:
capturing parameters of independent features of a participant video conference session, wherein the independent features include physical configurations of a video conference setup of a participant;
obtaining a feedback rating for the participant video conference session;
applying model analysis of the participant video conference session based on the feedback rating and the parameters of the independent features to obtain a session effectiveness score; and
providing calibration suggestions of the parameters of the independent features to improve video conference sessions of the participant.

13. The system of claim 12, wherein applying the model analysis applies a logistic regression model with the feedback rating as a dependent variable and the parameters as independent variables with coefficients of the logistic regression model providing weighting indications for the parameters.

14. The system of claim 12, wherein the session effectiveness score includes weights of the independent features indicating an influence of the independent features on the feedback rating, and providing the calibration suggestions of the parameters of the independent features based on the weights of the independent features.

15. The system of claim 12, further comprising categorizing the participant video conference session by a session type and applying the model analysis based on the session type.

16. The system of claim 12, wherein providing the calibration suggestions includes providing a display of the calibration suggestions in the participant's video conference system.

17. The system of claim 12, wherein capturing the parameters of the physical configurations is carried out by an extension to a video conferencing system, and wherein providing the calibration suggestions includes providing a configuration of the parameters via the extension.

18. The system of claim 12, wherein capturing the parameters of the independent features of the participant video conference session includes the independent features of participant input characteristics, and wherein providing the calibration suggestions of the parameters of the independent features includes providing participant input suggestions.

19. The system of claim 12, wherein capturing the parameters of the independent features in a form of the physical configurations includes object detection in a video display area, and providing the calibration suggestions includes providing object positioning suggestions in a remediated view.

20. A computer program product, comprising:
one or more tangible computer-readable storage devices and program instructions stored on at least one of the one or more tangible computer-readable storage devices, the program instructions executable by a processor, the program instructions comprising:
capturing parameters of independent features of a participant video conference session, wherein the independent features include physical configurations of a video conference setup of a participant;
obtaining a feedback rating for the participant video conference session;
applying model analysis of the participant video conference session based on the feedback rating and the parameters of the independent features to obtain a session effectiveness score; and
providing calibration suggestions of the parameters of the independent features to improve video conference sessions of the participant.
